(19) United States
(12) Patent Application Publication
(10) Pub. No.: US 2024/0061665 A1
(43) Pub. Date: Feb. 22, 2024

(54) INFORMATION PROCESSING DEVICE, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventor: Shinnosuke NAKASHIMA, Anjo-shi (JP)

(73) Assignee: TOYOTA JIDOSHA KABUSHIKI KAISHA, Toyota-shi (JP)

(21) Appl. No.: 18/365,374

(22) Filed: Aug. 4, 2023

(30) Foreign Application Priority Data
Aug. 18, 2022 (JP) 2022-130486

(51) Int. Cl. G06F 8/61

(52) U.S. Cl. CPC G06F 8/61

(57) ABSTRACT

An information processing device is communicably connected to, in a vehicle, a first information processing device and a second information processing device mounted on the vehicle. The first information processing device and the second information processing device respectively include platforms capable of executing a same application. When the first information processing device is in a state in which the first information processing device cannot execute a specific application installed in the first information processing device, a controller comprising at least one processor of the information processing device causes the second information processing device to install the specific application on the platform in the second information processing device. The controller of the information processing device causes the second information processing device to execute the specific application on the platform in the second information processing device.

### CROSS REFERENCE TO THE RELATED APPLICATION

This application claims the benefit of Japanese Patent Application No. 2022-130486, filed on Aug. 18, 2022, which is hereby incorporated by reference herein in its entirety.

### BACKGROUND

### Technical Field

The present disclosure relates to an information processing device, an information processing method, and a platform.

### Description of the Related Art

Japanese Patent Application Laid-Open No. 2020-160845 (Patent Literature 1) discloses an application installation device connected to a plurality of electronic control devices. The application installation device disclosed in Patent Literature 1 receives a first application that is an installation target and application usage information indicating a second application used by the first application. The application installation device determines, based on existing application information indicating existing applications respectively installed in the plurality of electronic control devices, when the second application is included as the existing applications, an electronic control device in which the first application and the second application can be installed among the plurality of electronic control devices as an installation destination of the first application. The application installation device transmits the first application to the determined electronic control device.

### SUMMARY

An object of the present disclosure is to provide a technique for, even if an information processing device mounted on a vehicle cannot execute an application, making it possible to execute the application with another information processing device.

An information processing device according to a first aspect of the present disclosure is an information processing device communicably connected to, in a vehicle, a first information processing device and a second information processing device mounted on the vehicle,
the first information processing device and the second information processing device respectively including platforms capable of executing a same application,
the information processing device including a controller comprising at least one processor configured to execute:
when the first information processing device is in a state in which the first information processing device cannot execute a specific application installed in the first information processing device, causing the second information processing device to install the specific application on the platform in the second information processing device; and
causing the second information processing device to execute the specific application on the platform in the second information processing device.

An information processing method according to a second aspect of the present disclosure is an information processing method executed by a computer communicably connected to, in a vehicle, a first information processing device and a second information processing device mounted on the vehicle,
the first information processing device and the second information processing device respectively including platforms capable of executing a same application,
the information processing method including:
when the first information processing device is in a state in which the first information processing device cannot execute a specific application installed in the first information processing device, causing the second information processing device to install the specific application on the platform in the second information processing device; and
causing the second information processing device to execute the specific application on the platform in the second information processing device.

A non-transitory storage medium according to a third aspect of the present disclosure is a non-transitory storage medium storing a platform included in a second information processing device mounted on a vehicle,
the platform performing, based on an instruction issued by a third information processing device mounted on the vehicle in response to a state in which a specific application installed in a first information processing device mounted on the vehicle cannot be executed, installation of the specific application and execution of the specific application.

According to the present disclosure, even if an information processing device cannot execute an application, it is possible to execute the application with another information processing device.

### BRIEF DESCRIPTION OF THE DRAWINGS

FIG. 1 is a diagram illustrating a schematic configuration of an information processing system in an embodiment;

FIG. 2 is a block diagram schematically illustrating an example of respective functional configurations of a first ECU, a second ECU, a vehicle-mounted device, and a distribution server;

FIG. 3 is a sequence chart illustrating a flow of information processing in the information processing system according to the embodiment;

FIG. 4 is a sequence chart illustrating a flow of information processing in an information processing system according to a modification 1; and

FIG. 5 is a sequence chart illustrating a flow of information processing in an information processing system according to a modification 2.

### DESCRIPTION OF THE EMBODIMENTS

An information processing device according to a first aspect of the present disclosure is information processing device communicably connected to a first information processing device and a second information processing device in a vehicle. The first information processing device and the second information processing device are mounted on the vehicle. The first information processing device is sometimes in a state in which the first information processing device cannot execute a specific application installed in the first information processing device. Then, harmful effects resulting from failure to use the specific application are likely to occur.

The first information processing device and the second information processing device respectively include platforms capable of executing the same application (hereinafter sometimes simply referred to as “platforms”). Consequently, the second information processing device is capable of installing the specific application and executing the specific application.

When the first information processing device is in a state in which the first information processing device cannot execute the specific application, a controller, comprising at least one processor, of the information processing device causes the second information processing device to install the specific application on the platform in the second information processing device. The controller of the information processing device causes the second information processing device to execute the specific application on the platform in the second information processing device.

As explained above, the specific application is installed on the platform in the second information processing device and the specific application is executed by the information processing device. In this way, even if the first information processing device cannot execute the specific application, the specific application can be executed by the second information processing device.

A specific embodiment of the present disclosure is explained below with reference to the drawings. Dimension, materials, shapes, relative disposition, and the like of components described in this embodiment are not meant to limit the technical scope of the present disclosure to only the dimensions, the materials, the shapes, the relative disposition, and the like unless particularly described.

### Embodiment

(Overview of System)

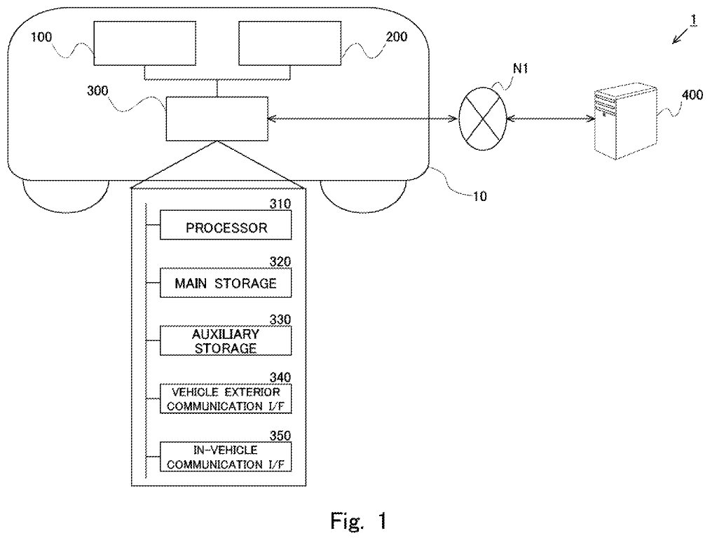

An information processing system 1 in this embodiment is explained with reference to FIG. 1. FIG. 1 is a diagram illustrating a schematic configuration of the information processing system 1 in this embodiment. The information processing system 1 includes a first ECU 100, a second ECU 200, a vehicle-mounted device 300, and a distribution server 400. In the information processing system 1, the first ECU 100, the second ECU 200, and the vehicle-mounted device 300 are connected to one another by an in-vehicle network. In the information processing system 1, the vehicle-mounted device 300 and the distribution server 400 are connected to each other by a network N1. As the network N1, for example, a WAN (Wide Area Network), which is a global-scale public communication network such as the Internet, or a telephone communication network such as a cellular phone may be adopted.

(First ECU)

The first ECU 100 is an electronic control unit mounted on a vehicle 10. An application concerning control of control target equipment of the first ECU 100 (hereinafter sometimes referred to as a “specific application”) is installed in the first ECU 100. The first ECU 100 executes the specific application to thereby control the control target equipment (hereinafter sometimes referred to as “target equipment”) of the first ECU 100.

The first ECU 100 is sometimes in a state in which the first ECU 100 cannot execute the specific application. As a case in which the first ECU 100 is in the state in which the first ECU 100 cannot execute the specific application, a failure of the first ECU 100 can be illustrated. In this case, since the first ECU 100 cannot control the target equipment, harmful effects resulting from failure to control the target equipment are likely to occur.

(Second ECU)

The second ECU 200 is an electronic control unit mounted on the vehicle 10. The first ECU 100 and the second ECU 200 respectively include platforms capable of executing the same application. In this embodiment, the first ECU 100 and the second ECU 200 includes a platform common thereto (hereinafter sometimes referred to as a “common platform”). Consequently, the second ECU 200 can install, on the common platform, the specific application to be executed by the first ECU 100. The second ECU 200 can execute the specific application on the common platform in place of the first ECU 100. In this way, the second ECU 200 can control the target equipment in place of the first ECU 100.

(Distribution Server)

The distribution server 400 is a server that retains the specific application. The distribution server 400 distributes the specific application. When receiving, from an external device, information for requesting transmission of the specific application (hereinafter sometimes referred to as “request information”), the distribution server 400 transmits the specific application to the external device. In this embodiment, the distribution server 400 transmits the specific application to the vehicle-mounted device 300.

(Vehicle-Mounted Device)

The vehicle-mounted device 300 is a device mounted on the vehicle 10. The vehicle-mounted device 300 manages a plurality of ECUs mounted on the vehicle 10 including the first ECU 100 and the second ECU 200. When the first ECU 100 cannot execute the specific application, the vehicle-mounted device 300 receives the specific application from the distribution server 400 via the network N1. Since the second ECU 200 includes the common platform, the second ECU 200 is capable of executing the specific application. Therefore, the vehicle-mounted device 300 causes the second ECU 200 to install the specific application received from the distribution server 400 on the common platform in the second ECU 200. The vehicle-mounted device 300 causes the second ECU 200 to execute the specific application on the common platform in the second ECU 200. Details of a method of the vehicle-mounted device 300 causing the second ECU 200 to install and execute the specific application are explained below.

The vehicle-mounted device 300 includes a computer including a processor 310, a main storage 320, an auxiliary storage 330, a vehicle exterior communication interface (vehicle exterior communication I/F) 340, and an in-vehicle communication interface (in-vehicle communication I/F) 350. The processor 310 is, for example, a CPU (Central Processing Unit) or a DSP (Digital Signal Processor). The main storage 320 is, for example, a RAM (Random Access Memory). The auxiliary storage 330 is, for example, a ROM (Read Only Memory). The auxiliary storage 330 is, for example, an HDD (Hard Disk Drive) or a disk recording medium such as a CD-ROM, a DVD disc, or a Blu-ray disc. The auxiliary storage 330 may be a removable medium (a removable storage medium). As the removable medium, for example, a USB memory or an SD card is illustrated. The vehicle exterior communication I/F 340 is, for example, a LAN (Local Area Network) interface board or a wireless communication circuit for wireless communication. The in-vehicle communication I/F 350 can be realized by a communication interface for the in-vehicle network included in the vehicle 10.

In the vehicle-mounted device 300, an operating system (OS), various programs, various information tables, and the like are stored in the auxiliary storage 330. In the vehicle-mounted device 300, the processor 310 can realize various functions explained below by loading the programs stored in the auxiliary storage 330 to the main storage 320 and executing the programs. However, a part or all of the functions in the vehicle-mounted device 300 may be realized by a hardware circuit such as an ASIC or an FPGA. Note that the vehicle-mounted device 300 does not always need be realized by a single physical component and may be configured by a plurality of computers that cooperate with one another. Like the vehicle-mounted device 300, the distribution server 400 also includes a computer.

(Functional Configuration)

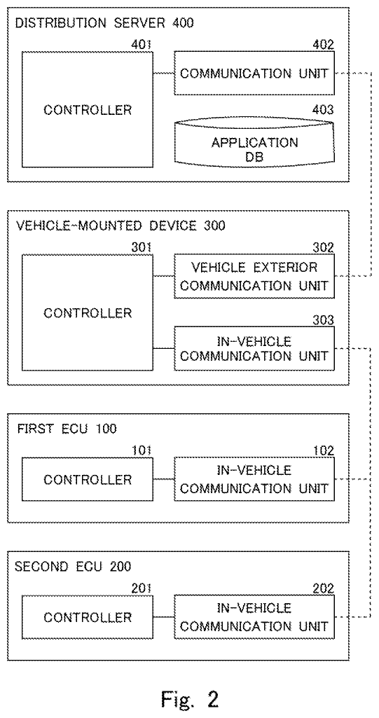

Subsequently, respective functional configurations of the first ECU 100, the second ECU 200, the vehicle-mounted device 300, and the distribution server 400 configuring the information processing system 1 are explained with reference to FIG. 2. FIG. 2 is a block diagram schematically illustrating an example of the respective functional configurations of the first ECU 100, the second ECU 200, the vehicle-mounted device 300, and the distribution server 400.

(First ECU)

The first ECU 100 includes a controller 101 and an in-vehicle communication unit 102. The controller 101 has a function of performing arithmetic processing for controlling the first ECU 100. The controller 101 can be realized by a processor in the first ECU 100. The in-vehicle communication unit 102 has a function of connecting the first ECU 100 to the in-vehicle network. The in-vehicle communication unit 102 can be realized by an in-vehicle communication I/F in the first ECU 100.

The controller 101 executes the specific application to control the target equipment. The controller 101 is sometimes in a situation in which the controller 101 cannot execute the specific application because of a failure or the like of the first ECU 100. When the controller 101 is in the situation in which the controller 101 cannot execute the specific application, the controller 101 outputs an error message indicating that the specific application cannot be executed (hereinafter sometimes simply referred to as an “error message”). The controller 101 grasps that the controller 101 is in a state in which the specific application cannot be executed when the error message is output. Then, the controller 101 transmits un-executability information to the vehicle-mounted device 300 with the in-vehicle communication unit 102. The un-executability information is information indicating that the first ECU 100 (the controller 101) is in the state in which the first ECU 100 (the controller 101) cannot execute the specific application.

(Distribution Server)

The distribution server 400 includes a controller 401, a communication unit 402, and an application database (application DB) 403. The controller 401 has a function of performing arithmetic processing for controlling the distribution server 400. The controller 401 can be realized by a processor in the distribution server 400. The communication unit 402 has a function of connecting the distribution server 400 to the network N1. The communication unit 402 can be realized by an in-vehicle communication I/F in the distribution server 400.

The application DB 403 has a function of retaining a plurality of applications retained by the distribution server 400. The specific application is also included in the plurality of applications retained by the application DB 403. The application DB 403 can be realized by an auxiliary storage in the distribution server 400. The controller 401 receives, with the communication unit 402, request information from the vehicle-mounted device 300. The request information is information for requesting the distribution server 400 to transmit the specific application. When receiving the request information, the controller 401 transmits, with the communication unit 402, the specific application to the vehicle-mounted device 300.

(Vehicle-Mounted Device)

The vehicle-mounted device 300 includes a controller 301, a vehicle exterior communication unit 302, and an in-vehicle communication unit 303. The controller 301 has a function of performing arithmetic processing for controlling the vehicle-mounted device 300. The controller 301 can be realized by the processor 310 in the vehicle-mounted device 300. The vehicle exterior communication unit 302 has a function of connecting the vehicle-mounted device 300 to the network N1. The vehicle exterior communication unit 302 can be realized by the vehicle exterior communication I/F 340 in the vehicle-mounted device 300. The in-vehicle communication unit 303 has a function of connecting the vehicle-mounted device 300 to the in-vehicle network. The in-vehicle communication unit 303 can be realized by the in-vehicle communication I/F 350 in the vehicle-mounted device 300.

The controller 301 receives, with the in-vehicle communication unit 303, un-executability information from the first ECU 100. Therefore, the controller 301 receives the un-executability information to thereby determine that the first ECU 100 is in a state in which the first ECU 100 cannot execute the specific application (hereinafter sometimes referred to as “un-executability determination”). After performing the un-executability determination, the controller 301 transmits, with the vehicle exterior communication unit 302, request information to the distribution server 400. Thereafter, the controller 301 receives, with the in-vehicle communication unit 303, the specific application from the distribution server 400.

When receiving the specific application from the distribution server 400, the controller 301 transmits, with the in-vehicle communication unit 303, instruction information to the second ECU 200. The instruction information is information for instructing the second ECU 200 to install the specific application received by the vehicle-mounted device 300 and execute the specific application. The instruction information includes a path of a directory in which the specific application is stored in the vehicle-mounted device 300 (hereinafter sometimes referred to as a “specific directory”). Consequently, the second ECU 200 can grasp a storage destination of the specific application. The instruction information is transmitted to the second ECU 200, whereby the second ECU 200 can install and execute the specific application received by the vehicle-mounted device 300.

(Second ECU)

The second ECU 200 includes a controller 201 and an in-vehicle communication unit 202. The controller 201 has a function of performing arithmetic processing for controlling the second ECU 200. The controller 201 can be realized by a processor in the second ECU 200. The in-vehicle communication unit 202 has a function of connecting the second ECU 200 to the in-vehicle network. The in-vehicle communication unit 202 can be realized by an in-vehicle communication I/F in the second ECU 200.

The controller 201 receives, with the in-vehicle communication unit 202, instruction information from the vehicle-mounted device 300. The controller 201 installs the specific application based on the instruction information. Specifically, the controller 201 acquires the specific application from the path of the specific directory and installs the specific application in the second ECU 200 based on the instruction information. The controller 201 executes the installed specific application based on the instruction information.

(Flow of Information Processing)

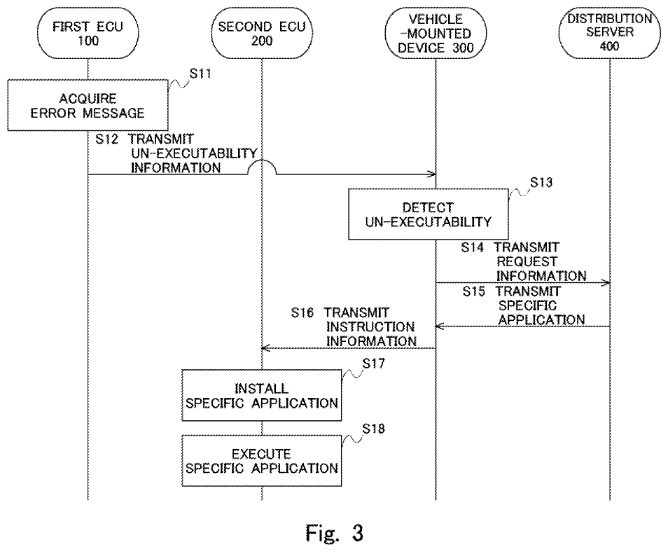

Subsequently, a flow of information processing in the information processing system 1 is explained with reference to FIG. 3. FIG. 3 is a sequence chart illustrating the flow of the information processing in the information processing system 1 according to this embodiment. Kinds of processing executed by the first ECU 100, the second ECU 200, the vehicle-mounted device 300, and the distribution server 400 are respectively executed by the controller 101, the controller 201, the controller 301, and the controller 401.

In the information processing system 1, the first ECU 100 acquires an error message (S11). Subsequently, the first ECU 100 transmits un-executability information to the vehicle-mounted device 300 (S12). The vehicle-mounted device 300 receives the un-executability information to thereby perform un-executability determination (S13). Then, the vehicle-mounted device 300 transmits request information to the distribution server 400 (S14). When receiving the request information, the distribution server 400 transmits the specific application retained by the application DB 403 in the distribution server 400 to the vehicle-mounted device 300 (S15). When receiving the specific application, the vehicle-mounted device 300 transmits instruction information to the second ECU 200 (S16). When receiving the instruction information, the second ECU 200 acquires the specific application from the specific directory and executes installation of the specific application (S17). The second ECU 200 executes the specific application (S18).

As explained above, in the information processing system 1, when the first ECU 100 cannot execute the specific application, the installation and the execution of the specific application are performed by the second ECU 200. Consequently, even if the first ECU 100 cannot execute the specific application, the specific application can be executed by the second ECU 200.

(Modification 1)

In this embodiment, the vehicle-mounted device 300 acquires the specific application from the distribution server 400. On the other hand, in this modification, the vehicle-mounted device 300 acquires the specific application from the first ECU 100. Only differences from the embodiment are explained below.

(Flow of Information Processing)

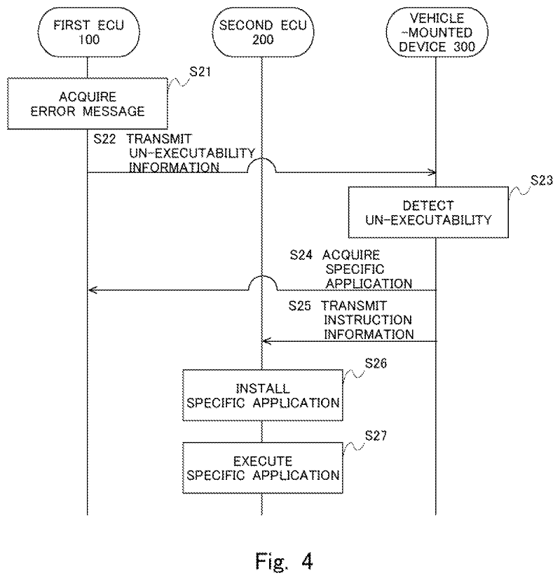

Subsequently, a flow of information processing in the information processing system 1 according to this modification is explained with reference to FIG. 4. FIG. 4 is a sequence chart illustrating the flow of the information processing in the information processing system 1 according to this modification. Kinds of processing executed by the first ECU 100, the second ECU 200, and the vehicle-mounted device 300 are respectively executed by the controller 101, the controller 201, and the controller 301.

In the information processing system 1 in this modification, the first ECU 100 acquires an error message (S21). Subsequently, the first ECU 100 transmits un-executability information to the vehicle-mounted device 300 (S22). The vehicle-mounted device 300 receives the un-executability information to thereby perform un-executability determination (S23). Therefore, the vehicle-mounted device 300 acquires the specific application from the first ECU 100 (S24). Specifically, the vehicle-mounted device 300 accesses a directory in which the specific application is retained in the auxiliary storage of the first ECU 100 and acquires the specific application retained in the directory. When acquiring the specific application, the vehicle-mounted device 300 transmits instruction information to the second ECU 200 (S25). When receiving the instruction information, the second ECU 200 executes installation of the specific application (S26). The second ECU 200 executes the specific application (S27).

As explained above as well, even if the first ECU 100 cannot execute the specific application, the specific application can be executed by the second ECU 200.

(Modification 2)

In this embodiment, the vehicle-mounted device 300 receives the un-executability information from the first ECU 100 to thereby perform the un-executability determination. On the other hand, in this modification, the vehicle-mounted device 300 receives the un-executability information from the distribution server 400 to thereby perform the un-executability determination. In this modification, the distribution server 400 manages execution of the specific application in the first ECU 100. Note that the management of the execution of the specific application in the first ECU 100 may be performed by a server different from the distribution server 400.

(Flow of Information Processing)

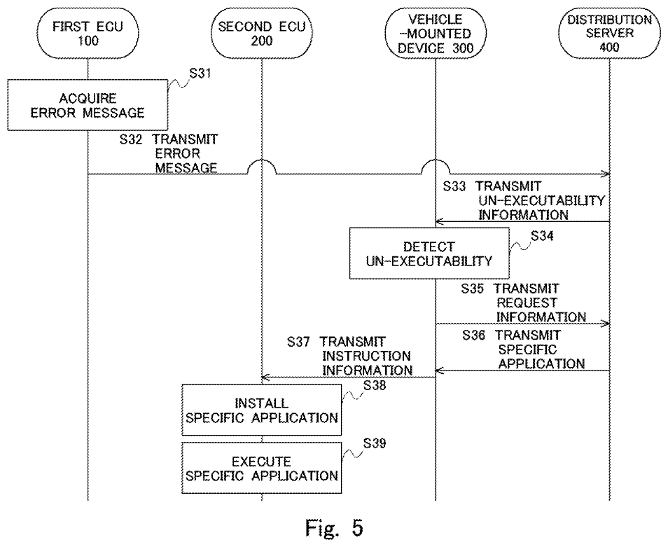

Subsequently, a flow of information processing in the information processing system 1 is explained with reference to FIG. 5. FIG. 5 is a sequence chart illustrating the flow of the information processing in the information processing system 1 according to this modification. Kinds of processing executed by the first ECU 100, the second ECU 200, the vehicle-mounted device 300, and the distribution server 400 are respectively executed by the controller 101, the controller 201, the controller 301, and the controller 401.

In the information processing system 1 in this modification, the first ECU 100 acquires an error message (S31). Subsequently, the first ECU 100 transmits the error message to the distribution server 400 (S32). By receiving the error message from the first ECU 100, the distribution server 400 can grasp that the first ECU 100 is in a state in which the first ECU 100 cannot execute the specific application. Therefore, the distribution server 400 transmits un-executability information to the vehicle-mounted device 300 (S33). When receiving the un-executability information from the distribution server 400, the vehicle-mounted device 300 performs un-executability determination (S34). Subsequently, the vehicle-mounted device 300 transmits request information to the distribution server 400 (S35). When receiving the request information, the distribution server 400 transmits the specific application to the vehicle-mounted device 300 (S36). When acquiring the specific application, the vehicle-mounted device 300 transmits instruction information to the second ECU 200 (S37). When receiving the instruction information, the second ECU 200 executes installation of the specific application (S38). The second ECU 200 executes the specific application (S39).

As explained above as well, even if the first ECU 100 cannot execute the specific application, the specific application can be executed by the second ECU 200.

### Other Embodiments

The embodiment explained above is only an example. The present disclosure can be changed and implemented as appropriate without departing from the gist of the present disclosure. The processing and the means explained in the present disclosure can be freely combined and implemented as long as technical contradiction does not occur.

Processing explained as being performed by one device may be shared and executed by a plurality of devices. Alternatively, processing explained as being performed by different devices may be executed by one device. In a computer system, it is possible to flexibly change by what kind of a hardware configuration (a server configuration) functions are realized.

The present disclosure can also be realized by supplying a computer program implemented with the functions explained in the embodiment above to a computer and one or more processors included in the computer reading and executing the program. Such a computer program may be provided to the computer by a non-transitory computer-readable storage medium connectable to a system bus of the computer or may be provided to the computer via a network. The non-transitory computer-readable storage medium includes, for example, a disk (disc) of any type such as a magnetic disk (a floppy (registered trademark) disk, a hard disk drive (HDD), or the like) or an optical disc (a CD-ROM, a DVD disc, a Blu-ray disc, or the like) or a medium of any type suitable for storing an electronic instruction such as a read-only memory (ROM), a random access memory (RAM), an EPROM, an EEPROM, a magnetic card, a flash memory, or an optical card.

What is claimed is:

1. An information processing device communicably connected to, in a vehicle, a first information processing device and a second information processing device mounted on the vehicle,
the first information processing device and the second information processing device respectively including platforms capable of executing a same application,
the information processing device comprising a controller comprising at least one processor configured to execute:
when the first information processing device is in a state in which the first information processing device cannot execute a specific application installed in the first information processing device, causing the second information processing device to install the specific application on the platform in the second information processing device; and
causing the second information processing device to execute the specific application on the platform in the second information processing device.

2. The information processing device according to claim 1, wherein the controller further executes
acquiring the specific application from a first server device that retains the specific application,
to cause the second information processing device to install the specific application acquired from the first server device.

3. The information processing device according to claim 1, wherein the controller further executes
acquiring the specific application from the first information processing device,
to cause the second information processing device to install the specific application acquired from the first information processing device.

4. The information processing device according to claim 1, wherein the controller further executes determining that the first information processing device is in a state in which the first information processing device cannot execute the specific application.

5. The information processing device according to claim 4, wherein, when acquiring, from the first information processing device, information indicating that the first information processing device is in the state in which the first information processing device cannot execute the specific application, the controller determines that the first information processing device is in the state in which the first information processing device cannot execute the specific application.

6. The information processing device according to claim 4, wherein, when acquiring, from a second server device that manages the execution of the specific application by the first information processing device, information indicating that the first information processing device is in the state in which the first information processing device cannot execute the specific application, the controller determines that the first information processing device is in the state in which the first information processing device cannot execute the specific application.

7. The information processing device according to claim 1, wherein the first information processing device and the second information processing device are electronic control units mounted on the vehicle.

8. An information processing method executed by a computer communicably connected to, in a vehicle, a first information processing device and a second information processing device mounted on the vehicle,
the first information processing device and the second information processing device respectively including platforms capable of executing a same application,
the information processing method comprising:
when the first information processing device is in a state in which the first information processing device cannot execute a specific application installed in the first information processing device, causing the second information processing device to install the specific application on the platform in the second information processing device; and
causing the second information processing device to execute the specific application on the platform in the second information processing device.

9. The information processing method according to claim 8, further comprising
acquiring the specific application from a first server device that retains the specific application,
to cause the second information processing device to install the specific application acquired from the first server device.

10. The information processing method according to claim 8, further comprising
acquiring the specific application from the first information processing device,
to cause the second information processing device to install the specific application acquired from the first information processing device.

11. The information processing method according to claim 8, further comprising determining that the first information processing device is in a state in which the first information processing device cannot execute the specific application.

12. The information processing method according to claim 11, wherein, when information indicating that the first information processing device is in the state in which the first information processing device cannot execute the specific application is acquired from the first information processing device, it is determined that the first information processing device is in the state in which the first information processing device cannot execute the specific application.

13. The information processing method according to claim 11, wherein, when information indicating that the first information processing device is in the state in which the first information processing device cannot execute the specific application is acquired from a second server device that manages the execution of the specific application by the first information processing device, it is determined that the first information processing device is in the state in which the first information processing device cannot execute the specific application.

14. The information processing method according to claim 8, wherein the first information processing device and the second information processing device are electronic control units mounted on the vehicle.

15. A non-transitory storage medium storing a platform included in a second information processing device mounted on a vehicle,
the platform performing, based on an instruction issued by a third information processing device mounted on the vehicle in response to a state in which a specific application installed in a first information processing device mounted on the vehicle cannot be executed, installation of the specific application and execution of the specific application.

16. The non-transitory storage medium according to claim 15, wherein the third information processing device:
acquires the specific application from a first server device that retains the specific application; and
instructs the second information processing device to install the specific application acquired from the first server device.

17. The non-transitory storage medium according to claim 15, wherein the third information processing device:
acquires the specific application from the first information processing device; and
instructs the second information processing device to install the specific application acquired from the first information processing device.

18. The non-transitory storage medium according to claim 15, wherein the third information processing device issues the instruction when determining that the first information processing device is in a state in which the first information processing device cannot execute the specific application.

19. The non-transitory storage medium according to claim 18, wherein, when acquiring, from the first information processing device, information indicating that the first information processing device is in the state in which the first information processing device cannot execute the specific application, the third information processing device determines that the first information processing device is in the state in which the first information processing device cannot execute the specific application.

20. The non-transitory storage medium according to claim 18, wherein, when acquiring, from a second server device that manages the execution of the specific application by the first information processing device, information indicating that the first information processing device is in the state in which the first information processing device cannot execute the specific application, the third information processing device determines that the first information processing device is in the state in which the first information processing device cannot execute the specific application.
